(19) United States
(12) Patent Application Publication
(10) Pub. No.: US 2018/0296982 A1
(43) Pub. Date: Oct. 18, 2018

(54) POLYMER MEMBRANES HAVING OPEN THROUGH HOLES, AND METHOD OF FABRICATION THEREOF

(71) Applicant: NATIONAL RESEARCH COUNCIL OF CANADA, Ottawa (CA)

(72) Inventors: Kebin LI, Montreal, QC (CA); Teodor VERES, Longueuil, QC (CA)

(73) Assignee: NATIONAL RESEARCH COUNCIL OF CANADA, Ottawa, ON, ON (CA)

(21) Appl. No.: 15/767,016

(22) PCT Filed: Oct. 6, 2016
(86) PCT No.: PCT/CA2016/051163

§ 371 Date: Apr. 9, 2018

Related U.S. Application Data
(60) Provisional application No. 62/244,170, filed on Oct. 20, 2015.

(51) Int. Cl. B01D 67/00

(52) U.S. Cl. CPC B01D 67/0032; B01D 67/0083; B01D 2325/028; B01D 2323/345; B01D 67/009

(57) ABSTRACT

Described are various embodiments of a method for fabricating a polymer membrane having open through holes, and membranes so produced. In some embodiments, a curable polymeric resin is introduced within a micro post structure wherein a material of the micro posts is soluble in a solvent and wherein the curable polymeric resin is insoluble in this solvent such that the structure can be at least partially dissolved to release the membrane once cured.

### FIELD OF THE DISCLOSURE

The present disclosure relates to polymer membranes, and, in particular, to polymer membranes having open through holes, and methods of fabrication thereof.

### BACKGROUND

Porous membranes not only find their applications in bio-sensing and chemical sensing, they are also the key components in the fabrication of filtration devices for macro- or micro-scale devices including lab-on-a-chip or micro total analysis systems. The perforations in the membrane can be used as a filter or can interconnect channels that are positioned above and below the membrane to form networks of 3D channels in the fabrication of 3D microfluidics systems. For such applications, the thickness of the membrane is usually in tens of micrometers and the pore size is about a few micrometers up to hundreds of micrometers. There are various types of materials that could be used as membranes for this application, which may include, but are not limited to rigid membranes such as Si membranes, SiN membranes and diamond membranes; thermal plastic membranes such as polycarbonate (PC) membranes, and PMMA membranes; and soft thermoplastic membranes such as PDMS and thermoplastic elastomers (TPE).

Among them, porous PC membranes, PDMS membranes and TPE membranes have been recently used in 3D microfluidic platforms. From the fabrication point of view, PC membranes with pore sizes varying from 100 nm to 20 um are commercially available and mostly fabricated using track etching methods. But the pores in PC membranes are discrete. The path of a pore is usually not straight because the PC membranes are formed through a combination of charged particle bombardment (or irradiation) and chemical etching.

TPE membranes having regular and straight open through holes have been fabricated using hot-embossing methods. That being said, this method is not conducive to the formation of high aspect ratios and sub-micrometer pore sizes, particularly for high throughput commercial application requirements.

Similarly, several challenges and limitations apply to the fabrication of regular and straight open-through hole membranes with PDMS materials using known spin coating or micro molding in capillaries (MIMIC) methods. These limitations include restrictions to low aspect ratios in membrane thickness to pore size, which translate into a limitation in membranes with pore sizes below 10 um given the difficulty in handling thinner membranes, as well as commercial limitations for membranes having larger pore sizes given the general fabrication methods' limited applicability for mass production. For instance, perforated PDMS membranes have been fabricated by spin coating of thin layer of liquid pre-polymer on a substrate that contains micro posts; the pre-polymer, when cured, is peeled off from the substrate to produce a membrane that contains holes defined by the micro posts. However, the meniscus of the liquid pre-polymer at the micro posts produces irregular features at the surface of the membrane. In addition, a very thin layer may stick on the surface of the micro posts which can result in the observation of blocked holes as it is generally difficult to completely remove the pre-polymer liquid thin layer between the substrate and micro posts, thus generally resulting in a low throughput process.

Another technique has been proposed to fabricate thin membranes with through holes by using a micro contact printing method from UV resin. In this process, a PDMS stamp is cut such that a micro post region of the stamp reaches its edge. It is then gently laid directly on a glass slide or other flat substrate. Then a drop of UV resin is deposited on the edge of the PDMS stamp and fills the gap between the substrate and the stamp by capillary action. After UV curing, the PDMS stamp is removed from the substrate and leaves the cured UV membrane on the surface of the substrate, which can be carefully peeled off from the fabrication substrate. This technique, however, also suffers from various drawbacks. For instance, the use of a PDMS stamp limits both the aspect ratio of the micro posts and the density of the posts. Namely, while PDMS provides advantages in the stamp removing process after UV curing, given its soft characteristics and elastomeric properties, as the PDMS pillars get denser and smaller, the heads of the posts increasingly risk getting tied together, especially when the aspect ratio of the posts is increased. Furthermore, as the gap between the substrate and the PDMS stamp is filled with UV resin by capillary action, it can form a very thin layer of resin on the bottom of the hole because of the capillary wetting of the UV resin underneath the micro posts of the PDMS stamp, which invariably results in blocked holes in the cured membrane. This issue becomes severe when the micro posts become smaller and denser.

As a solution to this problem, a MIMIC method was proposed to apply a force on top of the PDMS stamp to force the PDMS pillars to be tightly pressed on the surface of the substrate to avoid the UV resin wetting underneath the surface of the top of the micro posts. This method, however, becomes impracticable when the pillars get smaller as the micro posts become increasingly mechanically unstable given PDMS's low stiffness level.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for polymer membranes having open through holes, and methods of fabrication thereof, that overcome some of the drawbacks of known techniques, or at least, provides a useful alternative thereto. Some aspects of this disclosure provide examples of such membranes and fabrication methods.

In accordance with one aspect, there is provided a method of fabricating a polymer membrane having open through-holes defined therein, the method comprising: introducing a curable polymeric resin within a micro post structure defined by an array of sacrificial micro posts extending from a base surface structurally coupled thereto, wherein a level of said curable polymeric resin relative to said sacrificial micro posts once introduced is at most equal to a height of said sacrificial micro posts, wherein a sacrificial material of said micro posts is soluble in a solvent and wherein said curable polymeric resin is insoluble in said solvent; curing said polymeric resin to form the polymeric membrane within said micro post structure such that said array of micro posts extend through said polymeric membrane; and at least partially dissolving said array of sacrificial micro posts with said solvent so to release, and thus produce open through-holes within, said polymeric membrane.

In accordance with another embodiment, there is provided a polymer membrane manufactured in accordance with the above method.

In accordance with another embodiment, there is provided a method of manufacturing a polymer membrane having open through-holes defined therein, the method comprising: introducing a curable polymeric resin within a micro post structure defined by an array of sacrificial micro posts, wherein a level of said curable polymeric resin relative to said sacrificial micro posts once introduced is at most equal to a height of said sacrificial micro posts, wherein a sacrificial material of said micro posts is soluble in a solvent and wherein said curable polymeric resin is insoluble in said solvent, and wherein at least some of said micro posts are defined by a variable cross-section such that a longitudinal profile of the open through-holes defined within the polymer membrane once fabricated correspond with said variable cross-section; curing said polymeric resin to form the polymeric membrane within said micro post structure such that said array of micro posts extend through said polymeric membrane; and dissolving said array of sacrificial micro posts with said solvent so to produce open through-holes within said polymeric membrane.

In accordance with another embodiment, there is provided a polymer membrane having a plurality of micro-sized open through-holes formed therein, each one of which defined an identical longitudinal profile such that a first aperture dimension defined by each of said open through-holes at a first longitudinal position is distinct from a second aperture dimension defined at a second longitudinal position.

In accordance with another embodiment, there is provided a method of manufacturing a polymer membrane having nanoscale open through-holes defined therein, the method comprising: introducing a curable polymeric resin within a micro post structure defined by an array of sacrificial micro posts each having a nanoscale post portion extending therefrom, wherein a level of said curable polymeric resin relative to said sacrificial micro posts once introduced is at most equal to a height of said sacrificial micro posts, wherein a sacrificial material of said micro posts is soluble in a solvent, and wherein said curable polymeric resin is insoluble in said solvent; curing said polymeric resin to form the polymeric membrane within said micro post structure such that said array of micro posts extend through said polymeric membrane; and at least partially dissolving said array of sacrificial micro posts with said solvent so to produce open through-holes within said polymeric membrane.

In accordance with another embodiment, there is provided a polymer membrane having a plurality of nano scaled open through-holes formed therein, each one of which defined by a micro scaled hole portion adjoining one or more corresponding nano scaled hole portions.

In accordance with another embodiment, there is provided a method of fabricating a polymer membrane having open through-holes defined therein, the method comprising: introducing a curable polymeric resin within a micro post structure defined by an array of micro posts extending from a base surface structurally coupled thereto, wherein a level of said curable polymeric resin relative to said micro posts once introduced is at most equal to a height of said micro posts, wherein either one of a post material of said micro posts and said curable polymeric resin is reactive to a release fluid and whereas another of said post material and said curable polymeric resin is unreactive to said release fluid; curing said polymeric resin to form the polymeric membrane within said micro post structure such that said array of micro posts extend through said polymeric membrane; and exposing at least said reactive one of said micro posts and said polymeric resin to said release fluid so to mechanically release and thus produce open through-holes within said polymeric membrane.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram depicting a fabrication sequence for a thin UV resin membrane with regular and straight open through holes, in accordance with one embodiment, in which (A) shows a PDMS mould having an array of micro wells; (B) shows sacrificial PVA micro-posts replicated from the PDMS mould; (C) shows a sacrificial PVA structure after bonding the PVA micro-posts to a blank PET substrate coated with a thin layer of PVA resin or other water-based UV curable resin; (D) shows a

UV resin filling into the sacrificial PVA structure; and (E) shows the thin UV membrane once released from the sacrificial structure;

FIG. 2 is a cross-sectional view of the fabrication sequence of FIG. 1;

FIG. 3 a SEM image of an exemplary PDMS mold with an array of micro-wells (diameter of 20 um, depth of 40 um, and pitch of 50 um);

FIGS. 4A to 4E are SEM images of a UV resin membrane fabricated in accordance with one embodiment, in which FIGS. 4A and 4B are top side views of the membrane at 30 and 700 times magnifications, FIGS. 4C and 4D are bottom side views of the membrane at these same magnifications, respectively, with inset FIG. 4E providing a cross-sectional view of the membrane clearly showing open-through holes formed therein (hole diameter of about 20 um, pitch of about 50 um, and thickness of about 40 um).

FIGS. 5A to 5D are SEM images of a PVA sacrificial structure (5A) used in the fabrication of a membrane (5B to 5D) having an array of open through holes of diameter of about 13 um and pitch of about 100 um, in accordance with one embodiment, in which FIG. 5A shows PVA micro-posts replicated from a PDMS mould with micro wells as shown in FIG. 3; FIG. 5B shows a cross-sectional view of the open through hole membrane produced therewith; FIG. 5C shows a top view of the membrane; and FIG. 5D shows a bottom view of the membrane;

FIG. 6 is a schematic diagram depicting a fabrication sequence for a thin UV resin membrane with regular and straight open through holes, in accordance with another embodiment, in which (A) shows a PDMS mold with an array of holes replicated form a

Si master mold with pillars; (B) shows a sacrificial PVA structure having an array of micro-posts replicated from the PDMS mold; (C) shows filling of the PVA structure with resin via a wicking effect (i.e. capillary forces); and (D) shows the polymer membrane once cured and the PVA structure dissolved into water;

FIG. 7A is a SEM image of a PVA sacrificial structure used in the fabrication of a CUVR1534 membrane with a thickness of 80 um and an area of 16 mm by 33 mm, in accordance with the fabrication method illustrated in FIGS. 6A to 6D;

FIG. 7B is a photo, and FIGS. 7C and 7D are bottom side and top side SEM images, respectively, of the CUVR1534 membrane fabricated with the sacrificial structure of FIG. 7A;

FIG. 8 is a schematic diagram of a mask design for making UV cured polymer membranes, in accordance with one embodiment, with hole size below 10 um, in which (A) shows an array of 4 by 4 dies arranged on a 6-inch wafer; (B) shows a footprint of one 20 mm×20 mm die on this wafer, which can be used to produce a membrane sized at 16.5 mm×16.5 mm, and having one or more (e.g. three) top portion inlets for introducing a UV resin therein, and a rectangular bottom portion (e.g. 300 um×20 mm) to release air during the UV resin introduction; (C) shows an array of 55 by 55 cells, each sized at 300 um by 300 um; and (D) shows an enlarged view of a single one of these cells defined by an array of micro-posts having a diameter varying between 4 um and 8 um, and surrounded by a 40 um frame;

FIGS. 9A to 9D are respective SEM images of Si molds used in the fabrication of dies used in the fabrication of UV polymer membranes, in accordance with one embodiment, in which FIG. 9A shows a die with pillars in diameter of 8.0 um (the nominal size in design is 8 um); FIG. 9B shows a die with pillars in diameter of 3.5 um (the nominal size in design is 4 um); FIG. 9C shows a die with pillars in diameter of 4.3 um (the nominal size in design is 5 um); and FIG. 9D shows a die with pillars in diameter of 5.7 um (the nominal size in design is 6 um);

FIG. 10A is a photo of a fabricated polymer membrane on a glass slide;

FIG. 10B is a SEM image of the UV cured polymer membrane of FIG. 10A having a thickness of 18.8 um and fabricated using a sacrificial structure molded using an Si die mold as shown in FIG. 9 and arrayed as shown in FIGS. 8B to 8D, wherein the membrane consists of two levels: open through hole areas or cells defined by square cell areas of 220 um×220 um of thickness of 8.8 um, and a solid frame area of width of 80 um and thickness of 18.8 um surrounding the cells;

FIG. 10C is a SEM image of a given open-through hole area showing a hole diameter of about 5 um; and

FIG. 10D is a transmission diffraction pattern taken by a camera when the membrane is looked through a point white light source behind the membrane;

FIGS. 11A to 11D are SEM images of a UV cured polymer membrane with hole size of about 3 um, in which FIG. 11A is a zoomed out bottom SEM image view of the membrane; FIG. 11B is a zoomed in bottom SEM image view of a given cell of the membrane; FIG. 11C is a zoomed in top SEM image view of a given cell of the membrane; and FIG. 11D is a further zoomed in top SEM image view of the membrane within this given membrane.

FIG. 12 is a schematic diagram depicting a fabrication sequence for a thin UV resin membrane with regular and taper shaped open through holes, in accordance with another embodiment;

FIGS. 13A and 13E are SEM images of PVA pillars used for the fabrication of polymer membranes, whereas FIGS. 13B, 13C and 13D, and 13F, 13G, and 13H are SEM images of NOA84 membranes fabricated corresponding to the PVA pillars shown in FIGS. 13A and 13E respectively, wherein a scale bar shown in FIGS. 13A, 13C, 13D, 13E, 13G and 13H is 100 μm, as compared to 500 μm in FIGS. 13B 13F, and wherein FIGS. 13B, 13C, 13F and 13G are bottom side SEM images the membranes whereas FIGS. 13D and 13H are top side SEM images of the membranes;

FIGS. 14A to 14C are a set of SEM images of a three-level MD700 membrane with sub-micrometre feature size, the membrane consisting of an array of square holes (200 um by 200 um) in a 10 um recess, each square hole defining an array of 3 um open through holes with a thickness of 10 um, on top of which are defined an array of grating holes of about 400 nm in width with period of 800 nm; FIG. 14A is viewed from a bottom side of the membrane, FIG. 14B is viewed from a top side of the membrane and zoomed-in on one of the 200 um by 200 um square holes, while FIG. 14C provides a further zoomed-in view of the compounded membrane structure.

FIGS. 14D to 14F are a set of SEM images for a two-level MD700 membrane consisting of an array of open through holes with diameter of 14 um, on top of which is fabricated a sub-micrometre open through hole membrane with hole size around 500 nm; FIG. 14D is viewed from a bottom side of the membrane, FIG. 14E is viewed from a top side of the membrane, and FIG. 14F is a cross-section view of the membrane.

FIGS. 14G to 14I are a set of SEM images for another two-level MD700 membrane consisting of an array of open through holes with diameter of 14 um topped with an open through hole membrane with hole size of about 300 nm and pitch size of 600 nm arranged in a hexagonal configuration; FIG. 14G is viewed from a bottom side of the membrane, FIG. 14H is viewed from a top side of the membrane, and FIG. 14I provides a zoomed-in view of the tope side of the membrane further highlighting a structure of the second level;

FIGS. 15A and 15B are top and cross-sectional SEM images, respectively, of a MD 700 membrane with complex structure integrated open through holes in diameter of 10 um with micro pillars of 15 um in diameter and 30 um in height, in accordance with one embodiment;

FIG. 16A is a diagram of a hot embossing process for the fabrication of sacrificial template from an Si master having a two level micro/nano post structure;

FIGS. 16B and 16C are SEM images of an exemplary template fabricates in accordance with the process of FIG. 16A;

FIG. 17A is a diagram of a process for manufacturing a polymeric membrane having nanoscaled through holes using a template fabricated according to the process of FIG. 16A; and

FIGS. 17B to 17E are SEM images of an exemplary polymeric membrane manufactured using the template of FIG. 16B.

FIG. 18 is a schematic diagram of a biomarker detection system comprising a metallic film coated polymer membrane having tapered through holes, in accordance with one embodiment;

FIG. 19 is a schematic diagram of a metal-coated polymer membrane exhibiting an extraordinary optical transmission spectrum (i.e. middle and long infrared spectra) usable in security applications, in accordance with one embodiment;

FIGS. 20A to 20C are schematic diagrams of enclosable IR plasmonic security features based on metal film-coated polymer membranes, in accordance with one embodiment;

FIGS. 21A and 21B are schematic diagrams of a taper shaped polymer membrane coated with a super paramagnetic thin film in forming micro magnetic funnel-like channels for use in capturing and releasing target samples by activating (FIG. 21A) and deactivating (FIG. 21B) an eternal magnetic field;

FIGS. 22A to 22C are SEM images at different scales of a polymer membrane, as manufactured in accordance with the embodiments described herein, coated with a magnetic film on one side;

FIG. 22D is an SEM image of the metallic film once removed from the membrane of FIGS. 22A to 22C, which results in the formation of a freestanding metallic membrane with open through micro tubes;

FIGS. 22E and 22F are SEM images of another polymer membrane coated on both sides with a metallic film of about 2 um thickness;

### DETAILED DESCRIPTION

The following description of illustrative embodiments details various methods for fabricating polymer membranes having open through holes, and the various membranes fabricated and distinctly characterized by the implementation of such manufacturing processes.

For example, in some embodiments, methods are provided to fabricate thin polymer resin membranes with regular and straight open through holes based on a UV curable process. In some embodiments, the method involves the introduction of a curable polymeric resin within a micro post structure defined by an array of sacrificial micro posts extending from a base surface structurally coupled thereto. Once introduced, the polymeric resin is cured to form the polymeric membrane within the micro post structure such that the array of micro posts extends through the cured polymeric membrane. The sacrificial micro posts are then at least partially dissolved or otherwise released (e.g. shrunken) by an appropriate solvent or other fluid that is selected so to have little to no effect on the cured membrane, thus mechanically releasing, and consequently producing open through-holes within, the cured polymeric membrane. Different approaches and sequences in the provision of appropriate sacrificial structures for the manufacture of such membranes are provided below, along with different illustrative materials usable therein. Furthermore, as will be described in greater detail below, the development of this general manufacturing process has yielded many advantages in the fabrication of different membrane structures and configurations, as well as in the provision of an industrially scalable approach to membrane manufacture and various industrial applications for the membranes so produced.

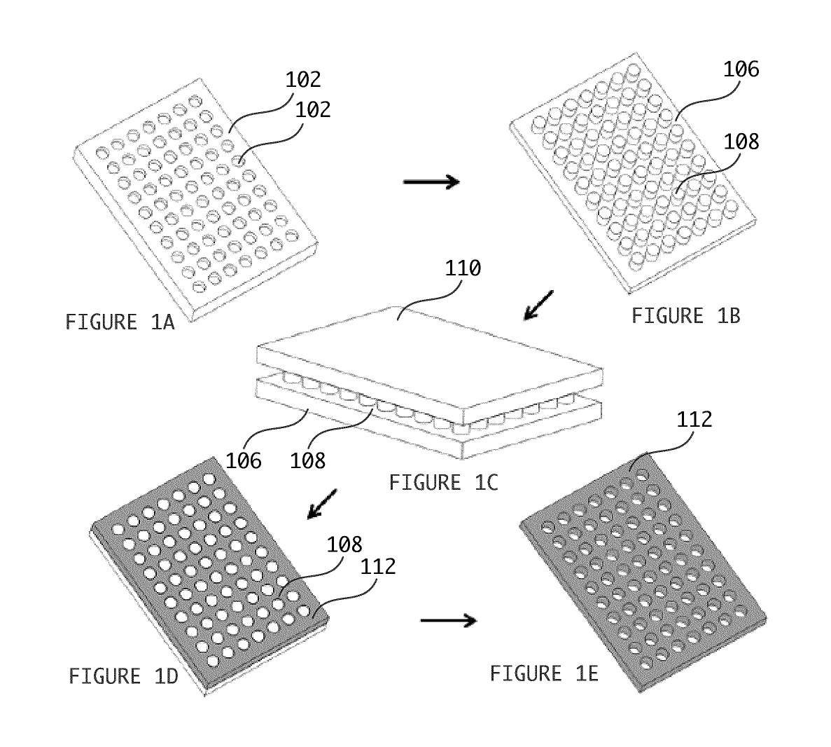

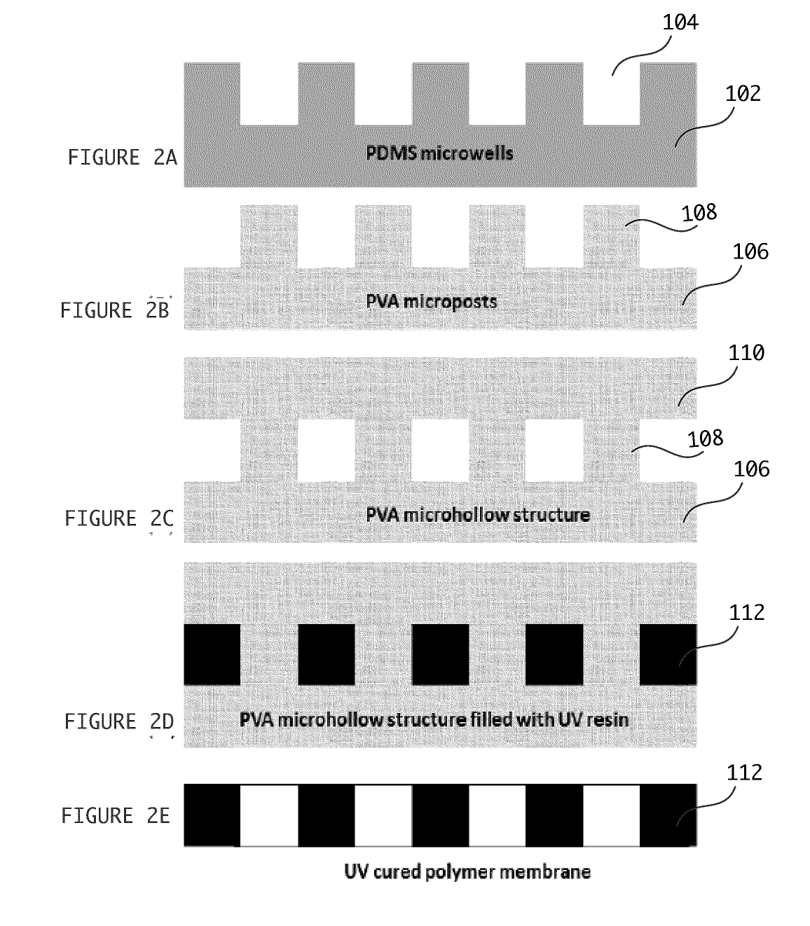

With particular reference to FIGS. 1 and 2, and in accordance with one embodiment, a polymer membrane fabrication process will now be described. In this example, a mold 102 is provided with an array of wells 104, the diameter and the depth of which corresponding to a desired membrane open through-hole aspect ratio. In one particular embodiment, the mold consists of a PDMS mould or the like replicated from a SU8 or Si mould fabricated using standard photolithography or deep ME and photolithography processes, though other examples may readily apply.

A layer of sacrificial material is then spin or otherwise coated on a substrate (e.g. Si wafer, glass slide, PET substrate, etc.). As will be appreciated below, a thickness of the membrane can also be more or less adjusted as a function of a thickness of the sacrificial layer coated on the substrate. In one particular embodiment involving the manufacture of water insoluble membranes, the sacrificial material consists of PVA or another water-soluble material such as poly (ethylene oxide) polymers or the like, which is spin coated onto the substrate, for example, for 40 s at 1000 rpm.

The mold 102 can then be laid and gently pressed against the coated substrate, making sure that the wells 104 in the mold 102 are adequately filled by the layered sacrificial material (e.g. to remove air bubbles if necessary). Once the sacrificial material has been cured (e.g. UV or thermally cured) or otherwise hardened, the mold can be gently removed from the substrate, which leaves a sacrificial layer 106 on the substrate with micro posts 108 extending outwardly therefrom, as shown in FIG. 1B.

In the meantime, a thin layer of sacrificial material (e.g. PVA or other water soluble and UV curable resin such as EBECRYL8411 and the like) is spin or otherwise coated on another substrate, such as a flexible PET substrate or the like, and bonded at the distal ends of the sacrificial micro-posts. Once cured (e.g. UV curing) or otherwise hardened, a three-dimensional sacrificial structure is formed between opposed sacrificial layers 106 and 110 defining a hollow network structure supported by the sacrificial posts 108, as shown in FIG. 1C. In general, the sacrificial structure can be formed using other methods such as hot-embossing or casting if the materials is not UV curable, for example.

Once the sacrificial structure is formed, a curable (e.g. UV curable) polymeric resin can be introduced into the hollow sacrificial structure, for example, via an inlet formed on the flexible PET substrate side. Such introduction may be executed via capillary forces or vacuum methods. For instance, the latter approach may involve putting a drop of curable resin on top of the inlet and leaving the structure inside a vacuum chamber such that, after venting, the curable UV resin will be rapidly sucked inside the sacrificial structure.

Once the curable resin has been cured, the flexible PET substrate is removed with the resin-filled sacrificial structure remaining, as shown in FIG. 1D. The sacrificial structure can then be dissolved in an appropriate solvent so to ultimately release a thin resin membrane 112 with regular and straight open through holes 114, as shown in FIG. 1E. For example, where the sacrificial material consists of PVA or another water soluble material, the sacrificial structure can be dissolved in DI water with ultrasonic for 5 to 10 minutes, and the resulting membrane with open-though holes dried by a nitrogen blow.

To further illustrate the process, FIGS. 2A to 2E provide diagrammatical cross-sectional views of the various steps, in which FIG. 2A illustrates the mold 102 having an array of micro-wells 104; FIG. 2B illustrates the sacrificial micro-posts 108 integrally formed to extend from the coated sacrificial layer 106; FIG. 2C illustrates the formed sacrificial structure defined by micro-posts 108 extending between opposed sacrificial layers 106 and 110; FIG. 2D illustrates introduction of the curable resin 112 within the structure of FIG. 2C; and FIG. 2E ultimately illustrates the resulting resin membrane 112.

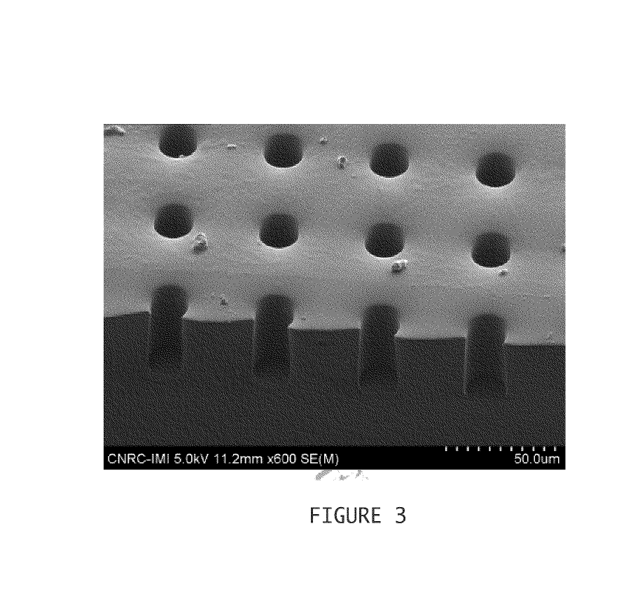

FIG. 3 provides a SEM image of a PDMS mould, such as mould 102 schematically illustrated in FIG. 1A, having an array of micro wells each having a 20 um diameter and depth of 40 um, and defining a pitch size of 50 um. In this particular example, the PDMS mould was fabricated from the casting of PDMS (10:1) on a Si mould with an array of Si pillars each having a 20 um diameter and 40 um height. The silicon mould was fabricated using deep reactive ion etching (DRIE) based on a Bosch process after a standard photolithography process.

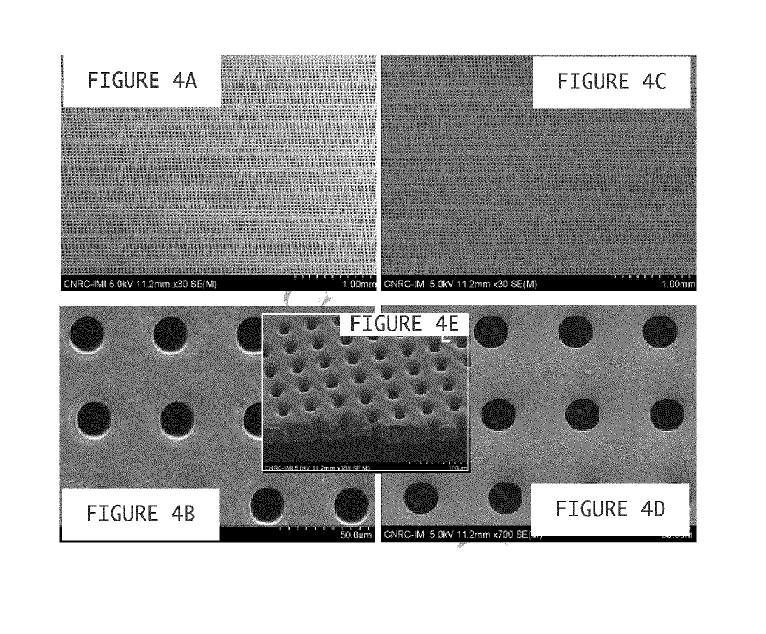

FIGS. 4A to 4E are SEM images of a UV resin membrane fabricated in accordance with the above-noted process and mold of FIG. 3, in which FIGS. 4A and 4B are top side views of the membrane at 30 and 700 times magnifications, FIGS. 4C and 4D are bottom side views of the membrane at these same magnifications, respectively, with inset FIG. 4E providing a cross-sectional view of the membrane clearly showing open-through holes formed therein (hole diameter of about 20 um, pitch of about 50 um, and thickness of about 40 um).

As can be seen from these images, the holes formed within the cured membrane are generally regular, straight and open on both sides. This particular membrane was fabricated to have a thickness of about 40 um and a hole diameter of about 20 um. The sacrificial resin used in this example was purchased from Cytec Industries Incorporated (Woodland Park, N.J., USA) under product name EBECRYL8411 and was diluted in IBOA (a product of the same company) in weight ratio of 1:3. Darocur® 1173 (1 wt. %, photo initiator) was added to the mixture and stirred for 30 minutes and degassed under vacuum.

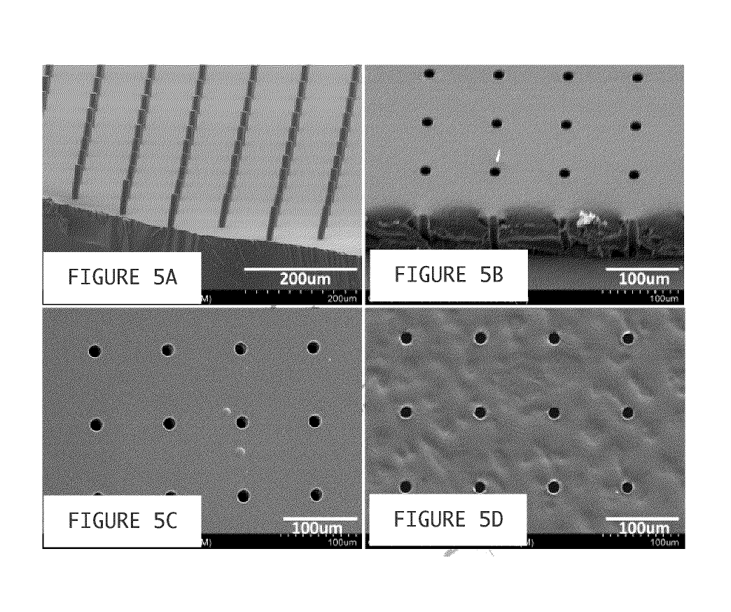

To demonstrate that the proposed method is applicable in the fabrication of membranes with pore sizes below 20 um and at a high aspect ratio, another PDMS mould was formed with an array of micro wells having a diameter of 13 um and depth of about 61 um. Using the fabrication process described above, UV resin membranes were successfully fabricated with regular and straight open through holes of 13 um diameter with an aspect ratio of about 5. FIG. 5A provides a SEM image of an exemplary PVA sacrificial (intermediary) structure used in the fabrication of such membranes, with FIGS. 5B to 5D showing SEM images of an exemplary membrane so fabricated to define an array of open through holes of diameter of about 13 um and pitch of about 100 um. In particular, FIG. 5B shows a cross-sectional view of the open through hole membrane so fabricated, whereas FIGS. 5C and 5D show top and bottom views of the membrane, respectively.

In the above-described embodiment, UV resin is advantageously introduced into an enclosed sacrificial structure via a vacuum filing method in that different resins can be used even if they are cationic or a free radical as long as they are not too volatile and do not later dissolve in the solvent used to dissolve the sacrificial structure. Alternatively, one can fill a given sacrificial structure via spontaneous capillary forces (SCF). The SCF filing process was shown to be generally straightforward to apply, and is relatively scalable in providing for increased production efficiency and scale.

With reference to FIG. 6, and in accordance with another embodiment, an alternative polymeric membrane fabrication process will now be described in which SCF is favoured as a filing process. As in the example of FIGS. 1 and 2, a mold 602 (FIG. 6A) with an array of holes 604 is replicated in PDMS or the like from a Si master, the master this time again fabricated using a DRIE method based on a standard photolithography process. The surface of PDMS mold in this example is coated with a monolayer of trichlorol(1H, 1H, 2H, 2H)-perfluorooctyl-silane (97%) (Sigma-Aldrich, Oakville, ON) by placing it under vacuum in a desiccator for two hours.

Once again, a template sacrificial structure (FIG. 6B) is replicated from the PDMS mold, again formed of polyvinyl alcohol (PVA, Sigma-Aldrich) or another water-soluble material, to define a series of sacrificial posts 608 extending from a base layer 606. In one example, a PVA solution is poured over the PDMS mold, which is then put under vacuum for an hour or so to remove air bubbles, and followed by drying slowly in an oven. For ease of handling, a PVA template thickness over 300 μm is preferred, though not necessary. The replicated PVA template is then detached from the PDMS mold, generally without any stiction issue. Alternatively, the PVA template can be molded using a casting technique, or the like.

Once the PVA posts 608 are replicated from PDMS mold 602, a drop of UV polymer resin 612 is brought to contact with the PVA posts 608 (see FIG. 6C), which results in the cavity of the PVA structure being spontaneously filled by the UV polymer resin so long as the surface of the PVA is hydrophilic to the UV polymer resin.

The physical mechanism behind this spontaneous filling process is based on the following phenomena. The roughness of a surface can enhance both the wetting (hydrophilic) and non-wetting (hydrophobic) ability of liquid on a solid surface. When the young's contact angle on a flat surface is less than 90°, roughness will reduce the apparent contact angle leading to a super-hydrophilic/super-wetting case. If the Young's contact angle is larger than 90°, the roughness will increase the apparent contact angle, leading to a super-hydrophobic/super-anti-wetting case. For a system of micro structured surfaces that consists of an array of micro pillars with diameter r and period L with pillar density of ϕₛ=πr²/L², the SCF of the liquid is possible via the menisci that form around each pillar, allowing the liquid to reach neighboring pillars. It forms in a manner similar to wicking, more accurately hemi-wicking, which is an intermediate between spreading and imbibition. The top surface of the pillars can be wet during the progression of the polymer film, but is generally unstable. The droplet on top of the pillars will eventually penetrate into cavities, leaving the top of a pillar dry, that's the typical Wenzel wetted state as long as there is no excess polymer to flood over the top of the pillars. To avoid the over-flooding of the liquid (polymer) on top of the pillars, an amount in the drop of polymer is controlled by putting it inside a reservoir during the filling process. For example, it may be practical to build a wide groove around the area to be filled as a reservoir, which can speed up the filling process while absorbing polymer excesses to avoid over-flooding the sacrificial structure.

As above, once introduced, the polymer resin is cured (e.g. via UV curing), and the sacrificial structure dissolved (e.g. in water) to release the polymeric membrane 614, as shown in FIG. 6D.

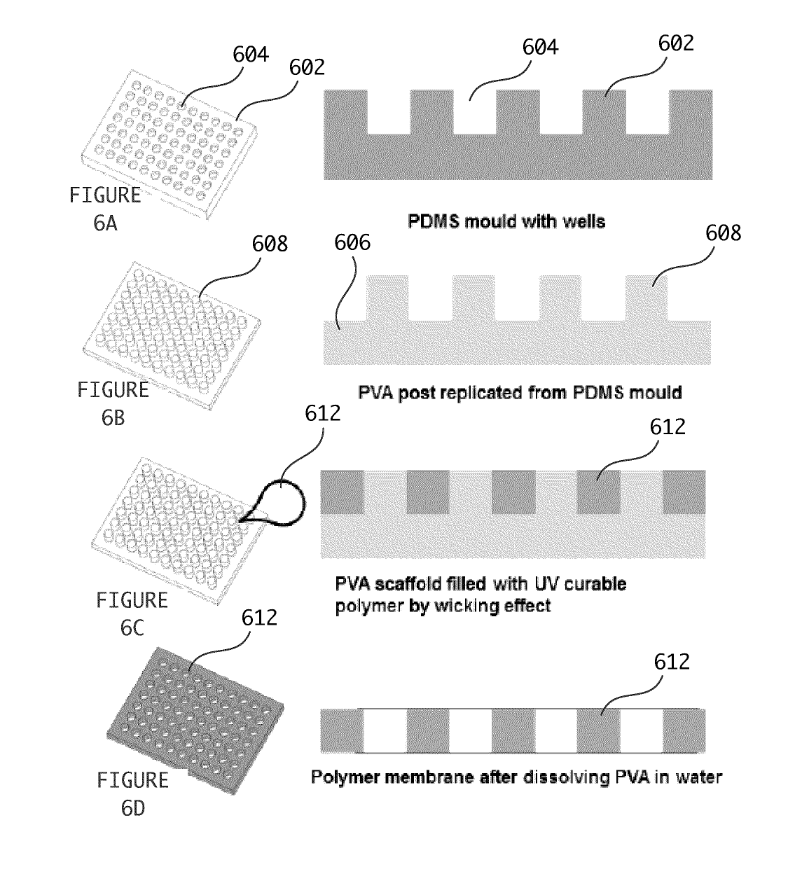

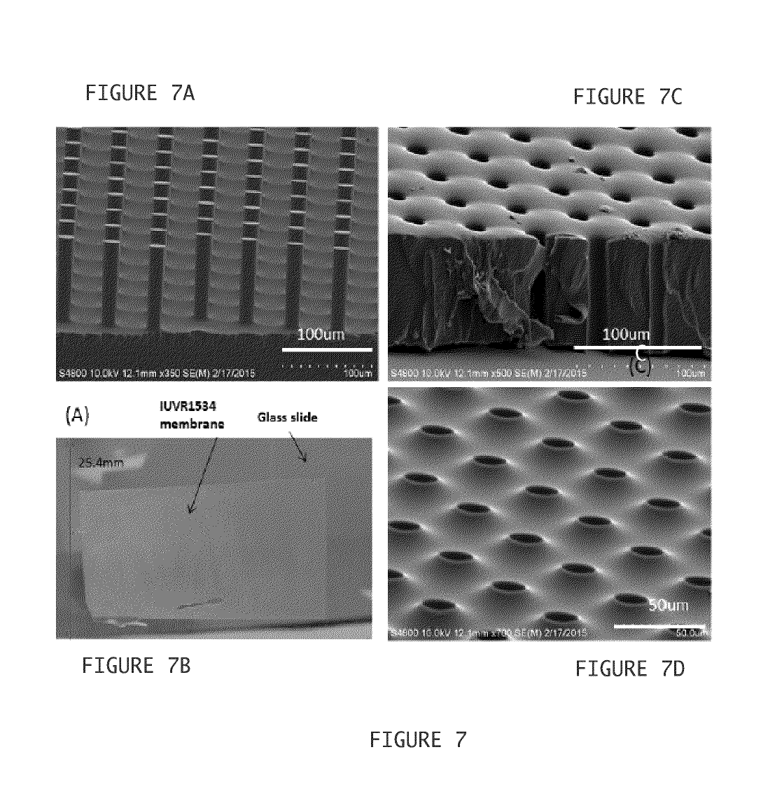

FIG. 7A provides a SEM image of an exemplary sacrificial structure, in this case consisting of roughly 80 um PVA pillars integrally formed to extend from a PVA platform, much as that schematically illustrated in FIG. 6A. FIG. 7B provides a photo of a CUVR1534 UV resin membrane fabricated in accordance with the method described above with reference to FIGS. 6A to 6D, using the sacrificial structure shown in FIG. 7A, whereas FIGS. 7C and 7D provide bottom cross-sectional and top plan SEM images of this membrane. In this particular example, the membrane has a thickness of about 80 um, which corresponds roughly with a height of the sacrificial PVA pillars, and an area of 16 mm by 33 mm. The UV resin used consisted of a mixture of UVACURE 1500 (Allnex Canada Inc., Ontario, Canada) and CAPA™ 3035 from (Perstrop, Sweden) in a ratio of 50:50 by weight. FIG. 7C clearly demonstrates that the holes formed in the membrane are straight and open-through; the diameter of the holes is about 16 μm. The surface is also shown to have formed to the base PVA surface around the pillars of the sacrificial structure. As shown in FIG. 7D, the top surface of the membrane exhibits a convex-shaped surface profile around the formed holes, which suggests that the surface of CUVR1534 resin filled by the capillary force around the PVA pillars has a convex shape, which is the typical shape of the water level inside a glass tube, indicating that the adhesive force between CUVR1534 and the side wall of the PVA pillars is larger than the cohesive energy of the CUVR1534. This convex shape is ultimately locked in after UV curing of the resin. In any event, the intended result is achieved.

In embodiments where the UV curing is done under ambient conditions, for most available free radical UV resins, the surface of the UV resin that is exposed to air cannot be fully cured because of oxygen inhibition issues. This can be addressed, however, by increasing the percent of photo initiator in the resin to make the surface of the resin partially cured and then add a drop of organic solvent on top of the resin to strip off oxygen molecules absorbed on the surface of the partially cured UV resin, followed by further UV exposure to fully cure the surface of the resin. In doing so, polymer membranes of free radical UV resin EBECRY 3708 (50% in TPGDA by weight) from Cytec (Allnex Canada Inc., Ontario, Canada) and polymer membranes of MD700 (Solvay Solexis MD 700 (PFPE urethane methacrylate) added with 1% of photo-initiator Darcure1173) were successfully fabricated. Membranes of optical adhesive UV resin with high refractive index, e.g. NOA 84 (Norland Products Inc., NJ) and of medical adhesive UV resin, e.g., 1161-M (Dymax Co.), were also successfully fabricated. Other solutions to the oxygen inhibition issue can also include, but are not limited to, providing UV exposure inside a glove box under a controlled environment when executing the process as shown of FIGS. 6A to 6D via SCF resin filling, for example, or again as demonstrated in the embodiment of FIGS. 1A to 1E using a vacuum filling method for an enclosed sacrificial structure where oxygen inhibition is altogether avoided by design.

While different materials can be used for the fabrication of the sacrificial structure, the use of PVA provides the advantage that there is less constraint in membrane polymer material selection, that is so long as the selected polymer is non-dissolvable in water.

As will be appreciated by the skilled artisan, while UV curable polymer membranes are contemplated in the above examples, the methods disclosed herein as not so limited as they may also be practiced in the fabrication of thermally curable polymer membranes, for example. For example, it was found that PDMS can also spontaneously fill a PVA structure, albeit at slower filling speeds than for other tested UV resins. Once the PVA structure is filled with PDMS, for example, it can be put inside an oven to thermally cure the PDMS, the PVA structure then being dissolved in DI water, as above, to release the cured PDMS membrane.

As noted above, PVA provides only one example of different intermediated materials usable in the fabrication of the sacrificial structure. For example, other UV materials can also be used so long as these materials can be dissolved in a particular solvent that does not concurrently affect the fabricated membrane being released therefrom. For example, UV cured resins such as EBECRYL8411, EBECRYL3708, etc. can be used to fabricate sacrificial structures in the fabrication of hydrophobic polymer membranes given the these resins can be partially dissolved in a DMSO solvent whereas hydrophobic polymers (e.g. such as perfluoroalkylpolyether (PFPE) Fluorolink® MD700) are not dissolved in DMSO. Ultimately, different sacrificial material and solvent selections can be made to accommodate different polymer membrane materials chosen based on the identification of appropriate solvents that will not dissolve or otherwise affect (e.g. shrink) the cured polymer membrane material, but that will sufficiently dissolve or affect (e.g. shrink) the selected sacrificial structure material to release the membrane once cured.

While the above examples demonstrate the effective fabrication of polymer membranes using the methods described herein, the following provides further demonstration as to applicability of the proposed methods not only in the fabrication of polymer membranes having through-hole sizes below 10 um, but also within the context of scalable industrial or commercial applications.

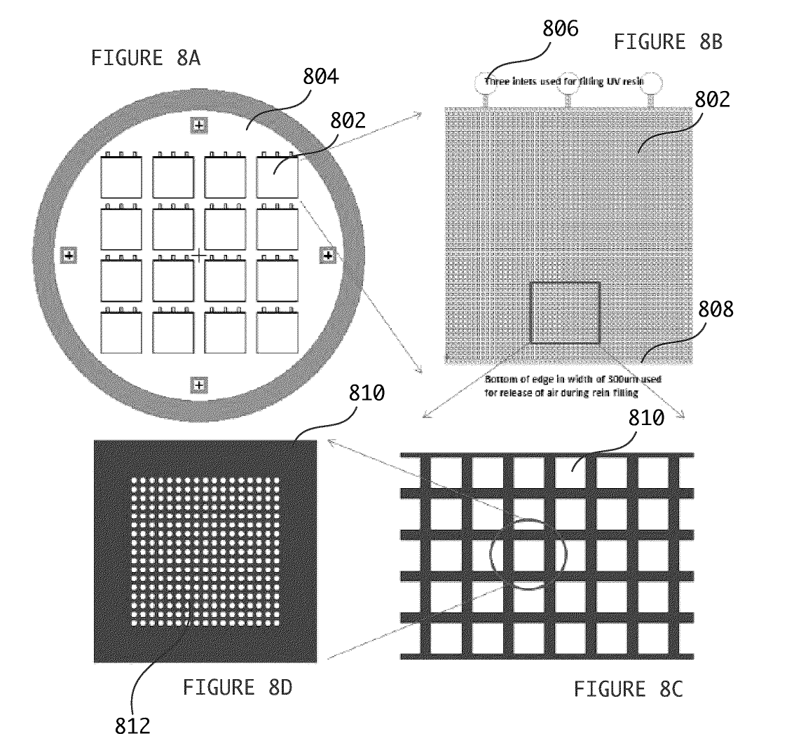

To this end, FIG. 8 is a schematic diagram of a mask design 800 for making UV cured polymer membranes, in accordance with one embodiment, with hole size below 10 um, in which (A) shows an array of 4 by 4 dies 802 arranged on a 6-inch wafer 804; (B) shows a footprint of one 20 mm×20 mm die 802 on this wafer, which can be used to produce a membrane sized at 16.5 mm×16.5 mm, and having one or more (e.g. three) top portion inlets 806 for introducing a UV resin therein, and a rectangular bottom portion (e.g. 300 um×20 mm) 808 to release air during the UV resin introduction; (C) shows an array of 55 by 55 cells 810, each sized at 300 um by 300 um; and (D) shows an enlarged view of a single one of these cells defined by an array of micro-posts having a diameter varying between 4 um and 8 um, and surrounded by a 40 um frame;

To this end, a 6-inch Si master mould mask design, as shown schematically in FIG. 8A, was developed to provide 16 dies 802 each having a footprint of about 2 cm by 2 cm and arranged in a 4×4 array.

As shown in FIG. 8B, each die 802 will generally include three inlets 806 at the top used for filing the die with UV resin (e.g. PDMS) in producing the molds later used to mold the actual sacrificial structures used in the final polymer membrane fabrication process, and a bottom strip 808 having a rectangular dimension of about 300 um×20 mm to release air during the UV resin filing process. Given this design, the actual size of a membrane fabricated from a given die will be about 16.5 mm×16.5 mm.

As further illustrated in FIG. 8C, each die consists of a 55×55 array of cells 810, each having a dimension of about 300 um×300 um. Each cell 810, as shown in FIG. 8D, consists of an array of holes 812 whose diameter is selected from 4 um, 5 um, 6 um and 8 um, respectively, depending on the membrane a given cell is to form a part of. For example, and as noted above, one 6-inch wafer can thus produce 16 membranes altogether, which are grouped into 4 groups of 4 membranes each defined by their respective hole size of 4 um, 5 um, 6 um and 8 um. From this design, and starting from a photo mask, a Si master mould was fabricated using standard photolithography and DRIE. FIGS. 9A to 9D show SEM images of such a Si master mold, as then used in the fabrication of UV polymer membranes, as described above. Namely, FIG. 9A shows a SEM image of a die with Si pillars of 8.0 um in diameter (the nominal size in the design is 8 um), FIG. 9B shows a SEM image of a die with Si pillars of 3.5 um in diameter (the nominal size in the design is 4 um), FIG. 9C shows a SEM image of a die with Si pillars of 4.3 um in diameter (the nominal size in the design is 5 um), and FIG. 9D shows a die with Si pillars with 5.7 um in diameter (the nominal size in the design is 6 um).

As will be noted, the actual size of the Si pillars is smaller than the nominal design value. Both the size of the Si pillar and the profile of the pillar can be tuned by adjusting the photolithography and DRIE process. Therefore, polymer membranes can also be fabricated using the processed described above to produce different pore sizes. As will be discussed in greater detail below, this process may also be employed in the fabrication of different pore profiles as well, i.e. different pore cross sectional shapes, sizes, orientations (e.g. angled pores) and even variable pore cross-section profiles (e.g. tapered or funneling pores).

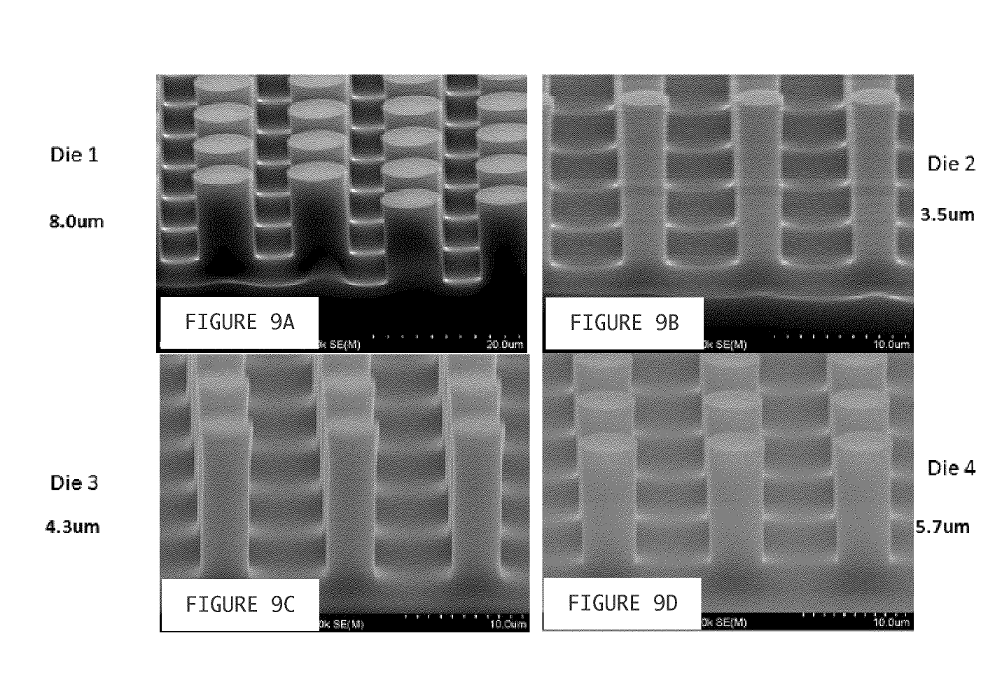

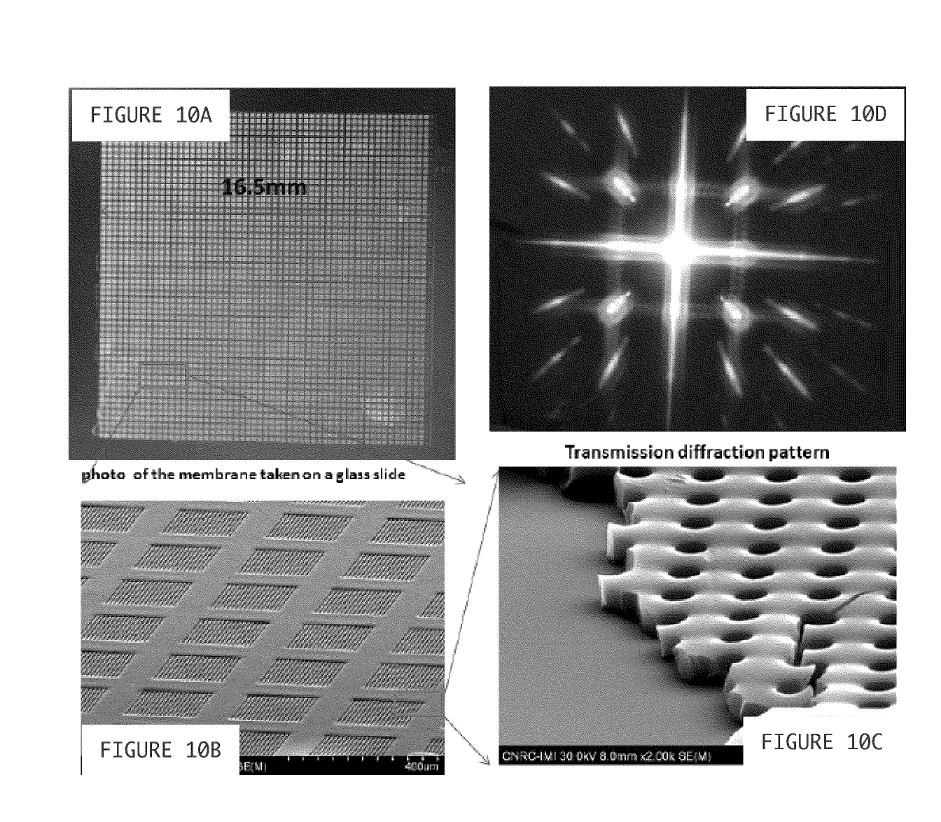

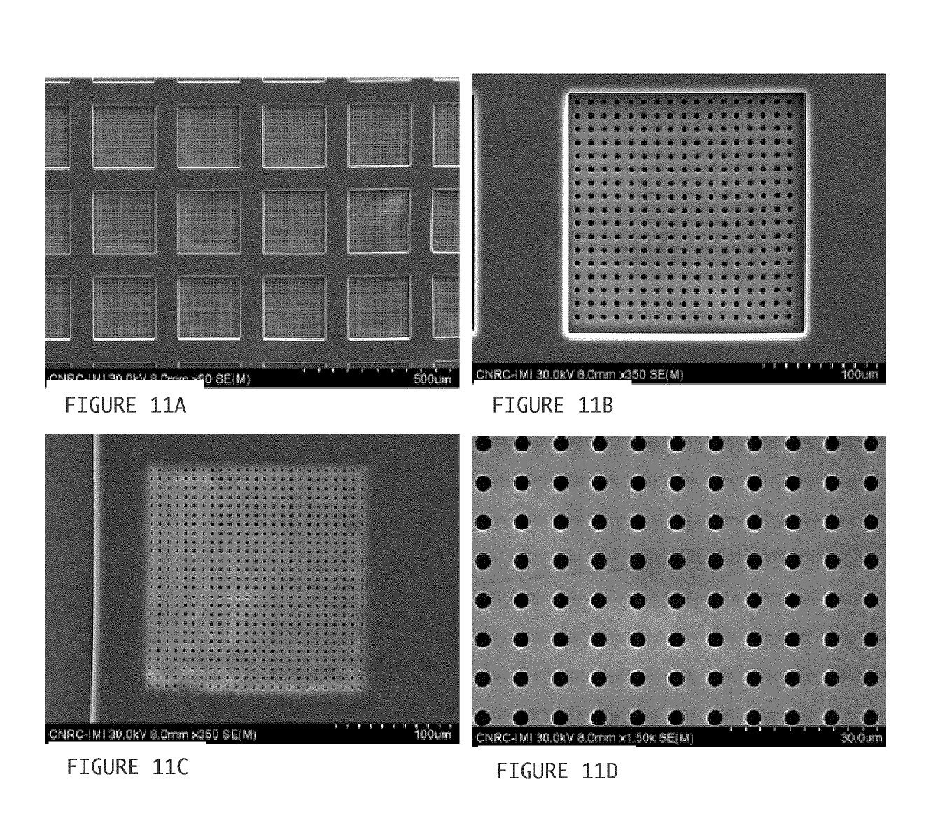

For instance, the images shown in FIG. 9A to 9D provide examples of Si master mold pillars with substantially 90° profiles which result in straight open through hole membranes, such as shown in the SEM images of FIGS. 10 and 11. For example, FIG. 10A shows a photo of a fabricated UV cured polymer membrane (MD700) free of defects on a glass slide. The SEM image shown in FIG. 10B shows the UV cured polymer membrane to consist of two levels, respective open through hole areas defined within respective square windows of 220 um×220 um with thickness of about 8.8 um, and a solid frame area 80 um in width and of thickness of about 18.8 um which encases these open through hole areas consistent with the 55×55 cell array of the master Si die. FIG. 10C shows that the diameter of a through hole of the membrane is about 5 um, whereas FIG. 10D shows a clear transmission diffraction pattern produced by a white point light source shone from behind the produced membrane and which consists of two superposed diffraction patterns that are attributed to the two-level array open through holes.

Likewise, FIGS. 11A to D show SEM images of a UV cured polymer membrane with hole size of 3 um, and distributed as described above in a 55×55 two-level cell array.

On the other hand, a similar approach may be employed to produce open through hole membranes having different pore profiles by adjusting the processing condition in the Si master mold fabrication, for example.

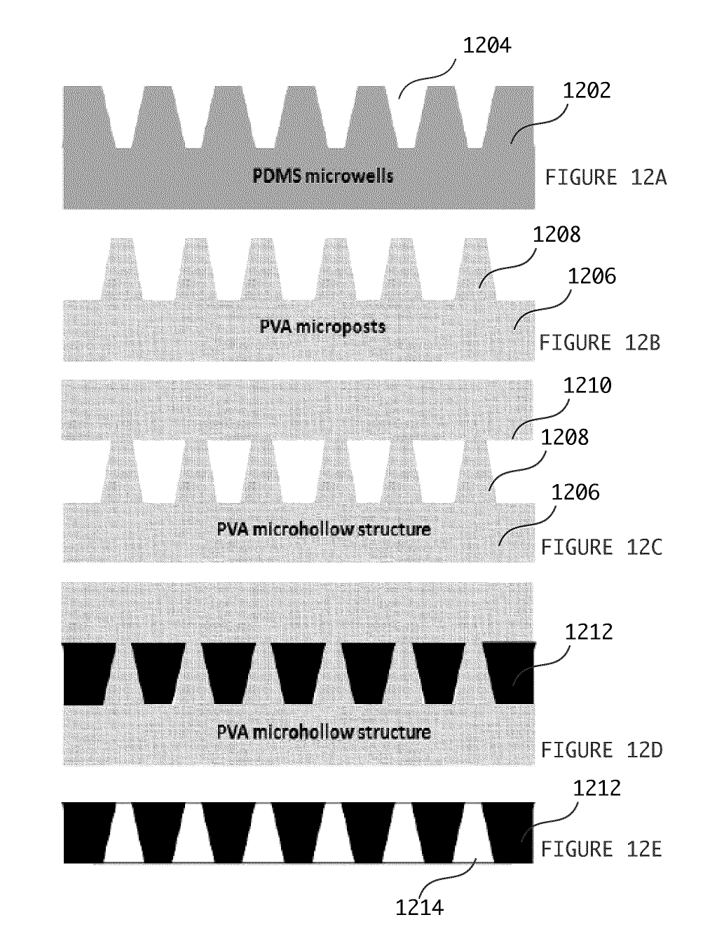

With reference to FIG. 12, and in accordance with another embodiment, a fabrication process for a polymer membrane having tapered through holes will now be described. In this example, as in the example of FIG. 1, a mold 1202 is provided with an array of wells 1204, the diameter and the depth of which corresponding to a desired membrane open through-hole aspect ratio. In this example, however, the wells are tapered in accordance with an intended membrane through hole profile. Once again, the mold may consist of a PDMS mould or the like replicated from a SU8 or Si mould fabricated using standard photolithography or DRIE and photolithography processes, though other examples may readily apply.

A layer of sacrificial material is then spin or otherwise coated on a substrate (e.g. Si wafer, glass slide, PET substrate, etc.). The mold 1202 can then be laid and gently pressed against the coated substrate, making sure that the wells 1204 in the mold 1202 are adequately filled by the layered sacrificial material (e.g. to remove air bubbles if necessary). Once the sacrificial material has been cured or otherwise hardened, the mold can be gently removed from the substrate, which leaves a sacrificial layer 1206 on the substrate with correspondingly tapered micro posts 1208 extending outwardly therefrom, as shown in FIG. 1B.

In the meantime, a thin layer of sacrificial material is spin or otherwise coated on another substrate, such as a flexible PET substrate or the like, and bonded at the distal ends of the tapered sacrificial micro-posts. Once cured (e.g. UV curing) or otherwise hardened, a three-dimensional sacrificial structure is formed between opposed sacrificial layers 1206 and 1210 defining a hollow network structure supported by the tapered sacrificial posts 1208, as shown in FIG. 1C.

Once the sacrificial structure is formed, a curable (e.g. UV curable) polymeric resin can be introduced into the hollow sacrificial structure. Once the curable resin has been cured, the flexible PET substrate is removed with the resin-filled sacrificial structure remaining, as shown in FIG. 1D. The sacrificial structure can then be dissolved in an appropriate solvent so to ultimately release a thin resin membrane 1212 with regular and tapered open through holes 1214, as shown FIG. 1E.

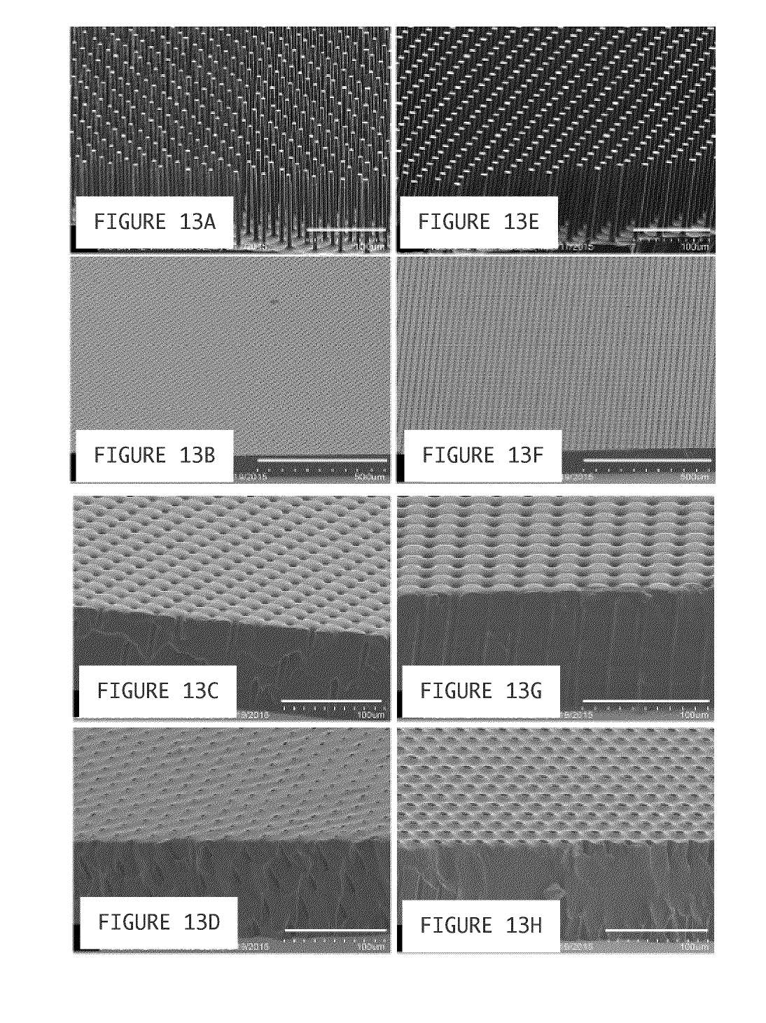

FIGS. 13A and 13E are SEM images of PVA pillars used for the fabrication of polymer membranes having high aspect ratio through holes, whereas FIGS. 13B, 13C and 13D, and 13F, 13G, and 13H are SEM images of distinct NOA84 membranes fabricated corresponding to the PVA pillars shown in FIGS. 13A and 13E respectively. FIGS. 13B, 13C, 13F and 13G provide bottom side SEM images of the membranes, whereas FIGS. 13D and 13H provide top side SEM images of the membranes. In this example, the smallest hole size is about 6 um and the thickness of the membrane is around 100 um which gives the aspect ratio (height over diameter) of about 16.7.

Using the above-described process, an aspect ratio of about 16.7 was achieved, though higher ratios are reasonably conceivable. As for the surface area of the membrane, it is eventually limited by the size of intermediated mold used in the process. For example, a 9 cm×9 cm intermediated PDMS mold was produced consisting of a 2×2 die array each with surface area of about 4.4 cm×4.4 cm, and four 2 mm grooves circumscribing each die for use as UV polymer filling reservoirs. Accordingly, 4 distinct polymer membranes each with dimension of 4.4 cm×4.4 cm could be concurrently fabricated using this sacrificial structure.

In accordance with yet another embodiment, the process disclose herein is applied to the fabrication of polymer membranes with pore sizes in the sub-micrometer regime. To do so, the proposed method was slightly modified by using a cover with sub-micrometer posts instead of a blank cover as described above with reference to FIG. 1C. Generally, these sub-micrometer sized posts will sit on top of the micro-sized posts defined by the first formation step of the sacrificial structure (e.g. micro posts 104 of FIG. 1B) after bonding the top cover to the bottom part, as shown for example in FIG. 1C. Once bonded, the sacrificial structure will be effectively defined by opposed sacrificial layers separated by layered arrays of micro and sub-micro sized posts. Practically, only those sub-micro-sized posts adjoining a micro-sized post in effectively defining a composite post having a micro-sized portion and one or more sub-micro-sized portions extending therefrom, will result in the formation of open through sub-micro-sized pores. Namely, once the structure is filled with a selected polymer material, the material is cured, and the sacrificial structure is dissolved, the resulting membrane will be operatively defined by an array of micro-sized pores overlaid by an array of sub-micro-sized pores. In a one-to-one configuration, the resulting pores will be represented by a discretely varying profile. In other more complex configurations, the resulting membranes may be characterized and multi-level membranes, as will be described in greater detail below.

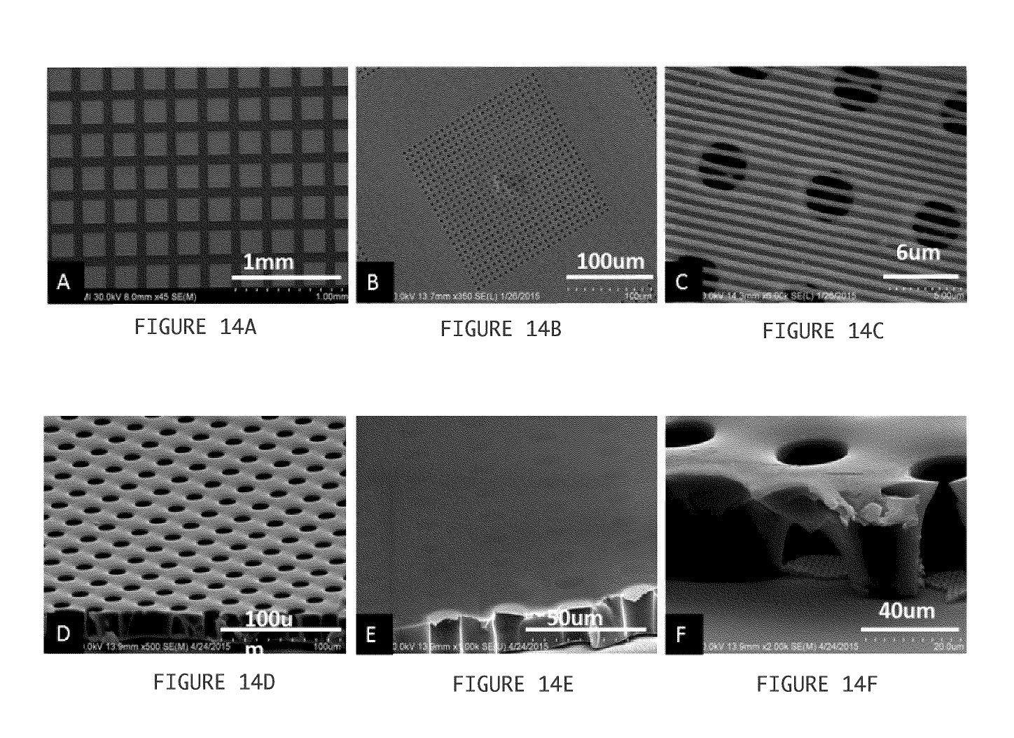

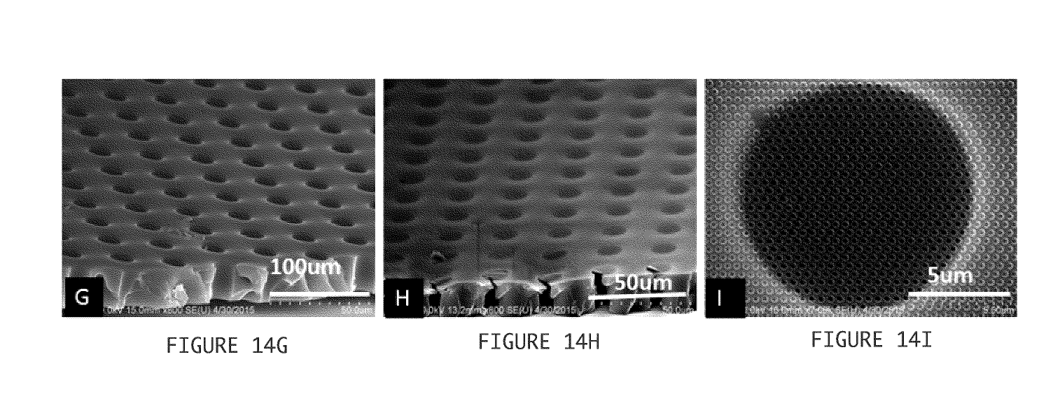

As noted above, one of the advantages provided by some of the embodiments described herein is that the sacrificial material used to mold the membrane is separated therefrom by a solvent rather than by using mechanical force as applied in most of other techniques used in polymer membrane fabrication. This advantage allows, for example, for the fabrication of polymer membranes with relatively high aspect ratios over large areas. FIGS. 14A to 14I provide a set of SEM images depicting various advanced membrane configurations and characteristics achievable using the methods described herein.

For example, FIGS. 14A to 14C are a set of SEM images of a three-level MD700 membrane with sub-micrometre feature size, the membrane consisting of an array of square holes (200 um by 200 um) in a 10 um recess, each square hole defining an array of 3 um open through holes with a thickness of 10 um, on top of which are defined an array of grating holes of about 400 nm in width with period of 800 nm. In particular, FIG. 14A is viewed from a bottom side of the membrane, FIG. 14B is viewed from a top side of the membrane and zoomed-in on one of the 200 um by 200 um square holes, while FIG. 14C provides a further zoomed-in view of the compounded membrane structure.

FIGS. 14D to 14F are a set of SEM images for a two-level MD700 membrane consisting of an array of open through holes with diameter of 14 um, on top of which is concurrently fabricated a sub-micrometre open through hole membrane with hole size around 500 nm. FIG. 14D is viewed from a bottom side of the membrane showing the micro-pore structure, whereas FIGS. 14E and 14F provide top side and cross sectional views of the membrane showing the nano-pore structure layered atop the micro-pore structure.

FIGS. 14G to 14I are a set of SEM images for another two-level MD700 membrane consisting of an array of open through holes with diameter of 14 um topped with an open through hole membrane with hole size of about 300 nm and pitch size of 600 nm arranged in a hexagonal configuration; FIG. 14G is viewed from a bottom side of the membrane showing the micro-pore structure, whereas FIG. 14H is viewed from a top side of the membrane showing the nano-pore structure layered atop the micro-pore structure. FIG. 14I provides a zoomed-in view of the top side of the membrane further highlighting the hexagonal configuration of the nano-pore structure. These examples provided for periodical grating and periodical hole (i.e. hexagonal hole) configurations with the smallest demonstrated hole size of 300 nm and pitch size of 600 nm. That being said, sub-100 nm open through-hole membranes should be readily achievable using this technique.

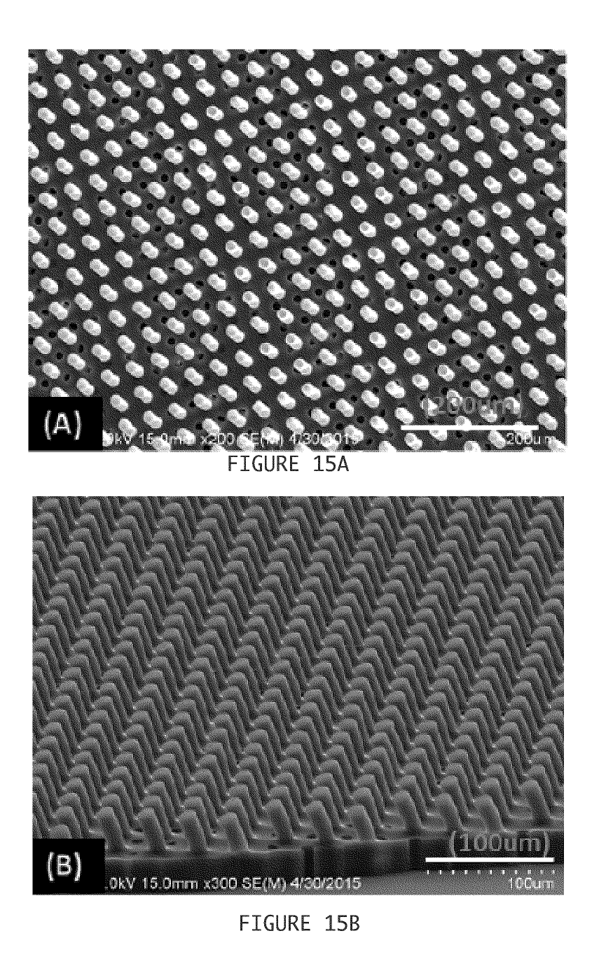

FIGS. 15A and 15B provide another example of a complex membrane structure manufactured in accordance with one embodiment of the process described herein. In this example, as shown by these SEM images, the integrated polymer membrane consists of an array of 10 um open through holes interspersed with a corresponding array of 15 um pillars.

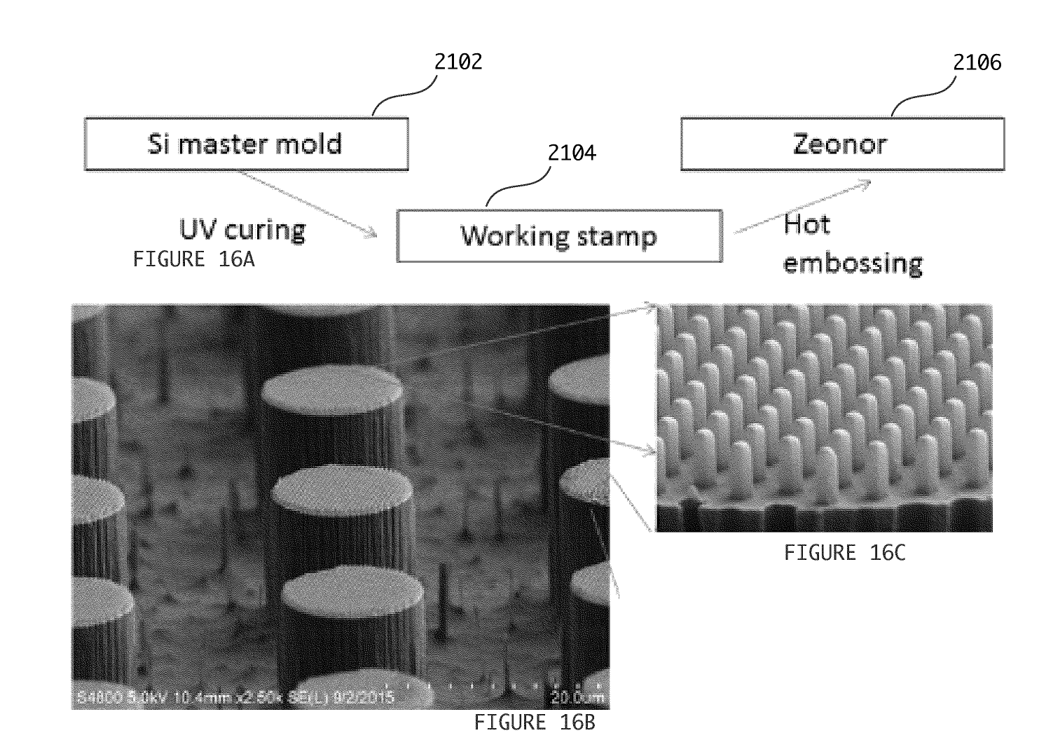

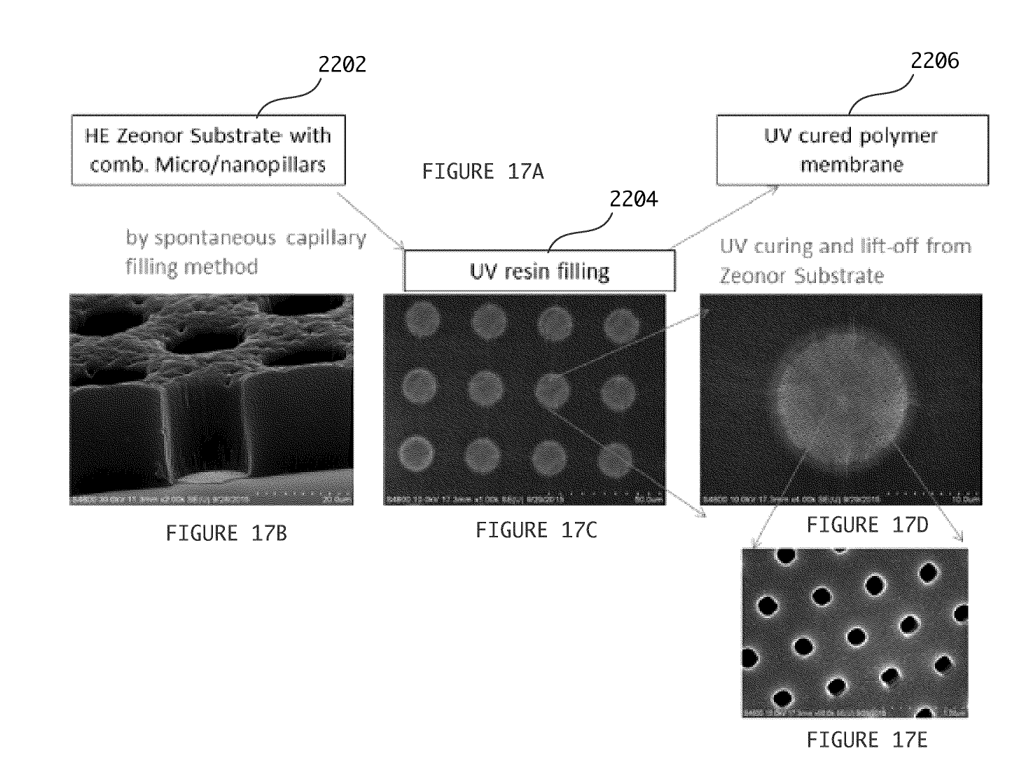

FIGS. 16A to 16C, and 17A to 17E provide another example of the manufacture of a multi-scale/multilevel membrane architecture, in particular, in achieving structurally sound membranes having nano-scaled open through apertures. In this example, a master mold is first manufactured to exhibit a combination of nanostructures with microstructures that can allow for the application of the SCF filling method described above rather than the vacuum filling method. In this example, a Si master mold was realized by both e-beam lithography and photo lithography processes.

A first array of Si nanopillars of 300 nm in square and 600 nm in height was first fabricated by e-beam lithography in a honeycomb configuration where the distance from each pillar to its six nearest surrounding pillars was fixed at 600 nm. This first 10 mm by 10 mm array was then integrated with an array of micropillars fabricated by photolithography to have a diameter of 15 μm, and pitch size of 30 μm, arranged in square configuration and covering an area of 40 mm by 40 mm The height of the micropillars was 30 μm and realized by DRIE. A Si master mold is thus produced with micropillars in an area of 40 mm by 40 mm, which includes a 10 mm by 10 mm area having complex pillars defined by an array of nanopillars atop a series of micropillars.

Using the Si master mold thus produced, an intermediate PVA scaffold can be fabricated using a casting method. For instance, in order to get PVA micropillars with an array of nanopillars on top, a Si master would need to be created to have an array of nanowells defined at the bottom of a corresponding array of microwells, which may be particularly challenging in terms of processing. As an alternative, an intermediate Zeonor template can be fabricated to have an array of nanopillars on top of micropillars by using an SCF filling method.

FIG. 16A illustrates a process to replicate Zeonor nano/micro structures from a Si master mold 2102, in which a working stamp 2104 which inverses the nano/micro structures of the Si master is used to produce an intermediate Zeonor 1060R template 2106 via hot embossing. FIG. 16B provides a SEM image of a hot-embossed Zeonor substrate having an array of nanopillars atop a complex micropillars array, with FIG. 16C providing an enlarged SEM image of the nanopillars in question. In this example, the resulting micropillars were 15 μm in diameter and 30 μm in height, whereas the nanopillars were approximately 220 nm square and 600 nm in height.

Zeonor 1060R is one type of cyclic olefin copolymer that is resistant to most chemicals like acids, bases and polar solvents, but less so to nonpolar solvents such as hexane, toluene and oils. Accordingly, Zeonor 1060R is not as amenable to the formation of a sacrificial structure in the manufacture of a polymer membrane according to the methods as described above as it is harder to find a chemical that can partially or totally dissolve Zeonor without or with limited attack to the polymer used to fabricate the membrane. However, some polar solvents can cause swelling of the polymer but without permanent damage thereto. Accordingly, instead of dissolving the sacrificial substrate in solvent, as above, the swelling of the polymer in some specific solvent can cause the cured polymer membrane to separate from the sacrificial scaffold to release the membrane. UV cured CUVR1534 is one such type of polymer that is particularly amenable to swelling without damage when it is immersed into methanol.

In one example, cationic CUVR1534 resin is introduced into a hot-embossed Zeonor complex two-level micro/nanopillar structure via SCF to produce a cured membrane having nano-scale open through holes. FIG. 17A illustrates the process, in which a complex HE Zeonor micro/nano structure 2202 is filed with a UV resin via SCF 2204 to produce a UV cured polymer membrane 2206 (e.g. CUVR1534) that can be lifted off from the Zeonor structure once immersed in an appropriate solvent, such as methanol, that sufficiently swells the membrane to accommodate such liftoff.

From the cross section SEM image shown in FIG. 17B, one observes that the UV cured CUVR1534 membrane consists of an array of microholes opening at one end while closed at the other end by a very thin layer of membrane whose thickness is about 550 nm. Under increasingly high magnification through FIGS. 17C, D and E, one observes the thin membrane consisting of an array of open through nanoholes whose size is about 220 nm. The surface of the top side of the membrane is smooth while the bottom side of the membrane appears porous. The porous surface at the bottom side is due to the sub-micro pins caused by the DRIE etching process during the fabrication of the Si master mold, which is consistent the SEM images of the hot-embossed Zeonor substrate shown in FIG. 16.

As noted above, porous membranes not only find their applications in bio-sensing and chemical sensing, they are also important in the fabrication of filtration devices for macro- or micro-scale devices including lab-on-a-chip or micro total analysis systems. For example, a plastic tip chip can be made from a plastic connector bonded with a UV cured polymer membrane, fabricated as described herein, and sandwiched between two PMMA sheets (e.g. 8 mm×8 mm in one example). The opening of the tip chip in this example has a diameter of about 2 mm, whereas the hole size of the UV cured membrane is about 7 um. The plastic tip chip can then be connected to a pneumatic platform to form a device demonstrating liquid shuttering by switching the platform from vacuum and pressure modes alternatively. This plastic tip chip could thus be used for cell separation (for example, in the capture of circulating tumor cells) and bio-sensing once the surface of the membrane is specifically treated with certain chemical agents.

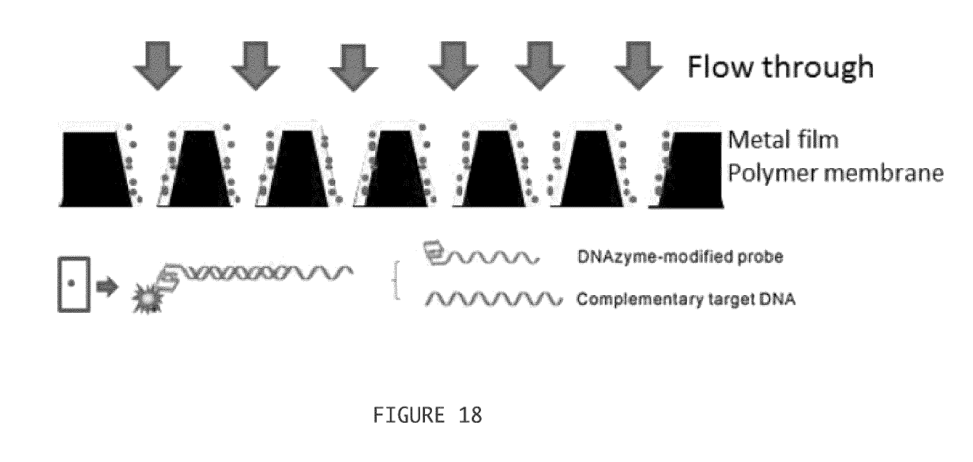

Si membrane-based flow-through microarray chips have been demonstrated in bio-sensing applications based on chemiluminescent (CL) emission. By depositing a metallic film on the surface of the polymer membrane and performing proper surface functionalization, a plastic tip chip as described above can also be applied for biomarker detection. To increase the CL intensity in this example, the number of target DNA molecules captured inside the pore walls of the membrane should also be increased, which is ultimately determined by the surface area of the inner wall of the holes. Accordingly, the provision of taper-shaped membrane holes can predictively boost the CL signal. FIG. 18 schematically depicts this approach for DNA detection based on a polymer membrane with taper-shaped open through holes. Namely, a membrane having a series of taper-shaped through-holes is first fabricated as described above, and coated with a metal film. As the target DNA molecules flow through the tapered pores, they are increasingly captured thereby, as confirmed by chemiluminescent emissions. In this particular embodiment, the polymer membrane is coated with a metallic thin film layer in order to make sure that the coated membrane is opaque. The surface of the metal coated membrane is functionalized in order to immobilize the probe DNA at the inner wall surfaces of the through holes by using a back and forth flow through method to maximize the immobilization of the probes. Once the probe DNA is adequately captured, the plastic tip chip is moved to another bath containing a target DNA solution, and the same back and forth flow through is applied in order to make rapid DNA hybridization, which hybridization events can be confirmed by the CL signal.

In another example, a polymer membrane as fabricated herein can be integrated into a microfluidic device used for particle and cell separation, for example.

Other exemplary applications may be derived from the controllable diffraction patterns observable through fabricated polymer membranes, as shown for example in FIG. 10D. For example, since the shape, size and pitch of the membrane through-holes fabricated using the herein-described process can be readily controlled, the resulting diffraction pattern can also be controllably and reproducibly predicted. Such polymer membranes could thus be used as security features in security documents, for example.

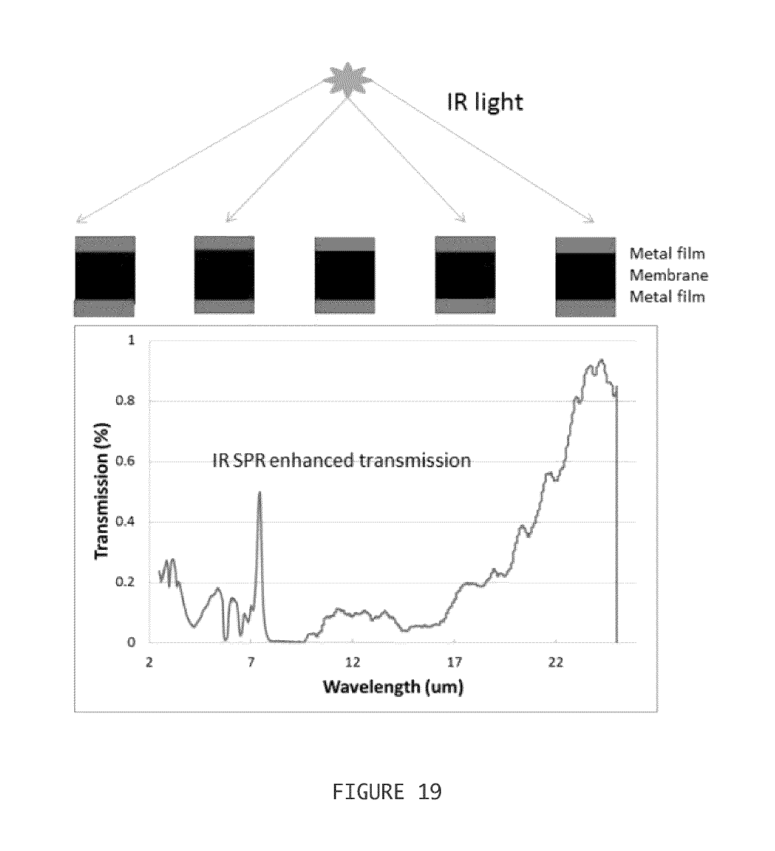

In addition to the controllable diffraction pattern, an extraordinary optical transmission can also be observed when coating a polymer membrane as described herein with a highly conductive thin film due to the infrared surface plasmonic effect. FIG. 19 provides an example of the extraordinary optical transmission observed in polymer membrane coated with a 60 nm Aluminum film. The diameter of membrane holes in this example is about 7 um.

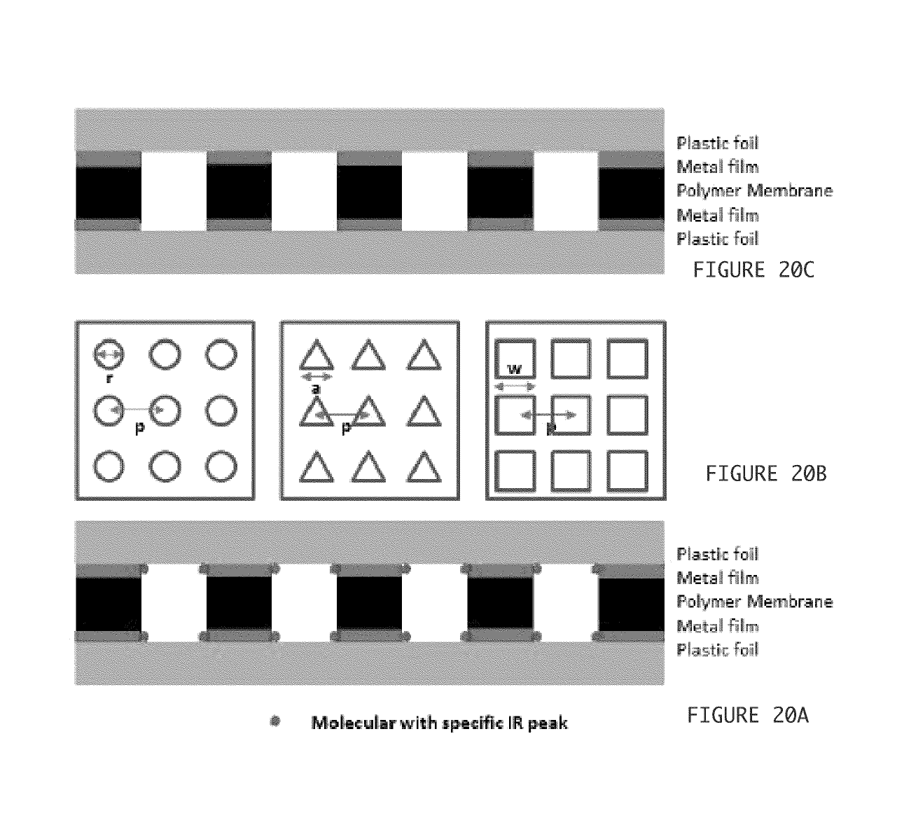

The extraordinary optical transmission features that appear due to IR plasmonic resonance in such polymer membranes when coated with a metal film can be used as biosensors and/or security features. For example, FIG. 20A provides one example of IR plasmonic security features based on a metal film-coated polymer membrane, in which the metal film-coated polymer membrane is embedded between plastic sheets in a security document. In this example, the security features can be detected based on the extraordinary IR plasmonic spectra depending on the structure of the membrane (for example, the shape and the diameter of the holes, as well as the pitch size of the array). For instance, FIG. 20B schematically illustrates different membranes having circular, triangular and square open through holes each defined by a respective size (i.e. radius, base and width, respectively) and pitch, thus predictively producing a respective characteristic extraordinary IR plasmonic spectrum. FIG. 20C provides another embodiment of an IR plasmonic security feature based on a thin metallic film-coated polymer membrane having a pre-encoded molecular IR reporter disposed within its pores to exhibit a characteristic IR plasmonic spectrum.

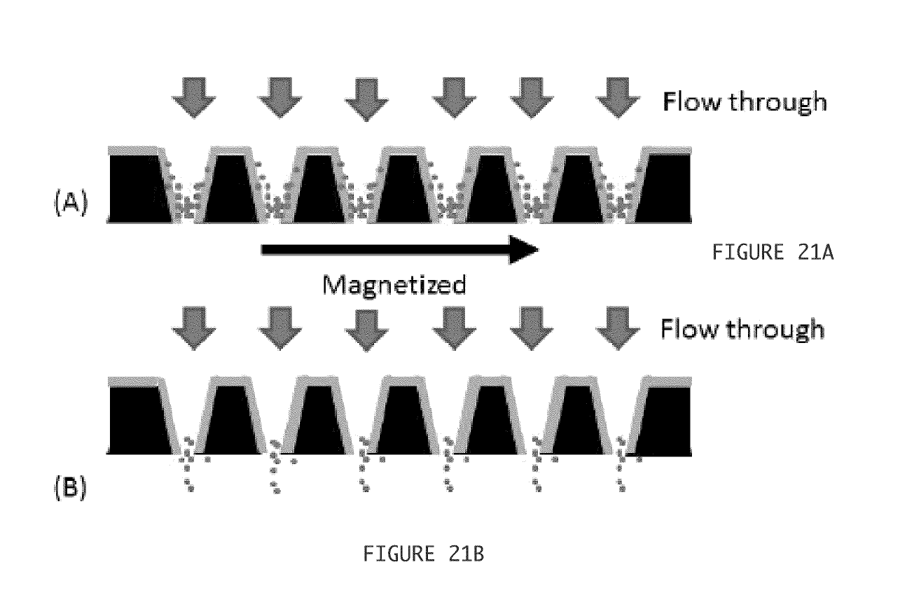

As discussed above, a polymer membrane fabricated as disclosed herein can be integrated into a microfluidic device for cell separation and biomarker detection, for example. Such membrane can also be applied during sample preparation. For example, a taper shaped polymer membrane coated with a super paramagnetic thin film will exhibit a strong magnetic force inside the membrane holes once the coated super paramagnetic film is magnetized (see FIG. 21A). The magnetic force will gradually become stronger as the opening of the hole gets smaller toward the bottom of the tapered hole. Accordingly, the taper-shaped open through holes will form micro magnetic funnel-like channels. If the biological samples (for example bacteria) are captured by functionalized magnetic nanoparticles, they can be efficiently trapped inside the micro magnetic funnel when the analyzed sample flows back and forth through the membrane. The captured bacteria can then be collected for further analysis upon releasing them from the micro magnetic funnels once the external magnetic field is removed, as shown in FIG. 21B. While a tapered profile may be advantageous in some embodiments, a similar approach may be applied using straight open-through holes, as will be readily appreciated by the skilled artisan.

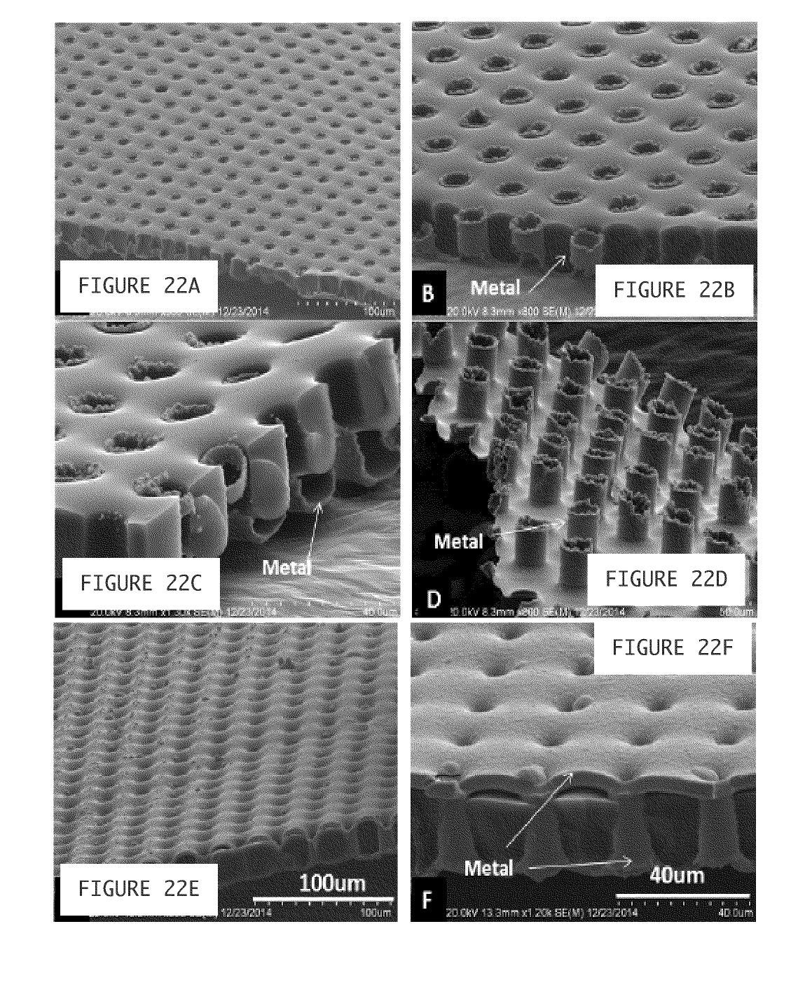

FIGS. 22A to 22C provide SEM images at different scales of a polymer membrane, as manufactured in accordance with the embodiments described herein, coated with a magnetic film on one side. In FIG. 22D, an SEM image is provided showing of the metallic film once removed from the membrane, the latter effectively acting as a stencil in the formation of a metallic micro tube array, namely a free-standing metallic membrane with open through micro tubes. In the SEM images of FIGS. 22E and 22F, another polymer membrane is shown, this time coated on both sides with a metallic film of about 2 um thickness.

In another embodiment, a super paramagnetic UV curable polymer membrane is fabricated by doping super paramagnetic or soft magnetic nanoparticles, nanowires, Nano pellets, Nano flakes or the like in the UV polymer. Using this approach, a super paramagnetic film need not be coated onto the UV polymer membrane.

Other applications may include, but are not limited to, 3D interconnects in electrical connections and packaging, as well as flexible electronic and biomedical devices, or example.

While the present disclosure describes various exemplary embodiments, the disclosure is not so limited. To the contrary, the disclosure is intended to cover various modifications and equivalent arrangements included within the general scope of the present disclosure.

1. A method of fabricating a polymer membrane having open through-holes defined therein, the method comprising:
introducing a curable polymeric resin within a micro post structure defined by an array of sacrificial micro posts extending from a base surface structurally coupled thereto, wherein a level of said curable polymeric resin relative to said sacrificial micro posts once introduced is at most equal to a height of said sacrificial micro posts, wherein a sacrificial material of said micro posts is soluble in a solvent and wherein said curable polymeric resin is insoluble in said solvent;
curing said polymeric resin to form the polymeric membrane within said micro post structure such that said array of micro posts extend through said polymeric membrane; and
at least partially dissolving said array of sacrificial micro posts with said solvent so to release, and thus produce open through-holes within, said polymeric membrane.

2. The method of claim 1, wherein said base surface is, or said base surface and an opposed surface are, of said sacrificial material, and wherein said dissolving further comprises dissolving said base surface or said base surface and said opposed surface.

3. The method of claim 1, wherein said array of micro posts extend between said base surface and an opposed surface thereby encasing said micro posts therebetween, and wherein said curable polymeric resin is introduced between said base surface and said opposed surface.

4. (canceled)

5. The method of claim 3, further comprising fabricating said micro post structure by:
providing said base surface with said array of micro posts integrally formed thereon; and
bonding a distal end of each of said micro posts to said opposed surface so to encase said array of micro posts therebetween.

6. (canceled)

7. The method of claim 5, wherein said providing comprises:
providing a mold defined by a series of micro wells shaped, sized and arranged so to correspond to said array of micro posts; and
integrally molding said array of micro posts within said base surface using said mold.

8. The method of claim 1, wherein at least some of said micro posts are defined by a variable cross-section such that a longitudinal profile of the open through-holes defined within the polymer membrane once fabricated correspond with said variable cross-section.

9. The method of claim 8, wherein said variable cross-section comprises a trapezoidal or conically tapering cross-section.

10. The method of claim 1, wherein said sacrificial material consists of a water-soluble material or is selected from the group consisting of PVA, a water-soluble poly (ethylene oxide) polymer, poly(acrylic) acid, Dextran, poly(methacrylic acid), poly(acrylamide), and poly(ethylene imine).

11. (canceled)

12. The method of claim 1, wherein said curable polymeric resin comprises a UV or thermally curable polymeric resin.

13.-20. (canceled)

21. The method of claim 1, wherein each of the sacrificial micro posts has a nanoscale post portion extending therefrom.

22. The method of claim 21, wherein each of said micro posts consists of a composite post comprising a micro scaled portion inwardly extending from the base surface, and said nanoscale portion inwardly extending from an opposed surface to align with said micro scaled portion in jointly forming said composite post while encasing said micro posts between said base surface and said opposed surface, and wherein said curable polymeric resin is introduced between said base surface and said opposed surface.

23. (canceled)

24. The method of claim 21, further comprising fabricating said micro post structure by:
providing said base surface with each said micro scaled portion integrally formed thereon;
providing an opposed surface with each said nano scaled portion integrally formed thereon; and
joining corresponding micro scaled portion and nano scaled portion ends to form each said composite post and encase said array between said based surface and said opposed surface.

25.-27. (canceled)

28. A method of fabricating a polymer membrane having open through-holes defined therein, the method comprising:
introducing a curable polymeric resin within a micro post structure defined by an array of micro posts extending from a base surface structurally coupled thereto, wherein a level of said curable polymeric resin relative to said micro posts once introduced is at most equal to a height of said micro posts, wherein either one of a post material of said micro posts and said curable polymeric resin is reactive to a release fluid and whereas another of said post material and said curable polymeric resin is unreactive to said release fluid;
curing said polymeric resin to form the polymeric membrane within said micro post structure such that said array of micro posts extend through said polymeric membrane; and
exposing at least said reactive one of said micro posts and said polymeric resin to said release fluid so to mechanically release and thus produce open through-holes within said polymeric membrane.

29. The method of claim 28, wherein said micro posts are at least partially dissolved by said release fluid.

30. The method of claim 28, wherein said micro posts are shrunken by said release fluid.

31. The method of claim 28, wherein said post material is selected from the group consisting of PVA, a water-soluble poly (ethylene oxide) polymer, poly(acrylic) acid, Dextran, poly(methacrylic acid), poly(acrylamide), poly(ethylene imine), and UV lacquers.

32. The method of claim 28, wherein said polymeric resin is swollen by said release fluid so to mechanically release said membrane from said micro posts.

33. The method of claim 32, wherein said post material consists of a cyclic olefin copolymer.

34. The method of claim 32, wherein said release fluid is methanol.

35. The method of claim 32, wherein said post material consists of Zeonor and said release fluid is methanol.
